(19) United States
(12) Patent Application Publication
(10) Pub. No.: US 2024/0347029 A1
(43) Pub. Date: Oct. 17, 2024

(54) Acoustic Pickup for Mounting on Musical Instrument Soundboard

(71) Applicant: Lloyd Baggs Innovations, LLC, Nipomo, CA (US)

(72) Inventors: Robert Radis, Nipomo, CA (US); Lloyd R. Baggs, Nipomo, CA (US); Thomas Linn, Nipomo, CA (US)

(73) Assignee: Lloyd Baggs Innovations, LLC, Nipomo, CA (US)

(21) Appl. No.: 18/633,295

(22) Filed: Apr. 11, 2024

Related U.S. Application Data
(60) Provisional application No. 63/495,512, filed on Apr. 11, 2023.

(51) Int. Cl. G10H 3/18; G10H 3/14

(52) U.S. Cl. CPC G10H 3/185; G10H 3/143; G10H 3/181; G10H 3/182; G10H 3/183; G10H 2220/525; G10H 2220/565

(57) ABSTRACT

Transducer pickup systems for acoustic stringed instruments are disclosed. In one embodiment, a pickup system includes at least two pickups, each pickup including a pickup housing and a bottom surface, the pickup housing having sides comprising at least a top wall, each pickup including an electromechanical transducer surrounded by a solid non-conductive material and located the same distance from the top wall and the bottom surface, and each pickup including adhesive on one of the sides of the pickup housing configured to mount the pickup to the underside of the soundboard of an acoustic stringed instrument.

### CROSS-REFERENCE TO RELATED APPLICATIONS

The present application claims priority under 35 U.S.C. § 119(e) to U.S. Provisional Application Ser. No. 63/495,512, entitled “Acoustic Pickup for Mounting on Musical Instrument Soundboard” to Radis et al, filed Apr. 11, 2023, the disclosure of which is expressly incorporated by reference herein in its entirety.

### FIELD OF THE INVENTION

The present invention relates generally to stringed musical instrument pickups and more specifically to improved designs of contact transducer pickups for mounting on an instrument soundboard.

### BRIEF DESCRIPTION OF THE DRAWINGS

FIG. 1 illustrates exterior and interior views of a soundboard transducer pickup in accordance with an embodiment of the invention.

FIG. 2 illustrates an interior view of a soundboard transducer pickup with dimensions in accordance with an embodiment of the invention.

FIG. 3 illustrates another interior view of a soundboard transducer pickup with dimensions in accordance with an embodiment of the invention.

FIG. 4A illustrates a mounting position of a pickup system in accordance with an embodiment of the invention.

FIG. 4B illustrates an active pickup system including soundboard transducer pickups in accordance with an embodiment of the invention.

FIG. 5 illustrates a process for manufacturing a soundboard transducer pickup in accordance with an embodiment of the invention.

FIG. 6 illustrates an interior view of an overmolded soundboard transducer pickup in accordance with an embodiment of the invention.

### DETAILED DISCLOSURE OF THE INVENTION

Acoustic pickups for mounting on a musical instrument soundboard in accordance with embodiments of the invention are disclosed.

Many embodiments include a piezoelectric transducer or other type of electromechanical transducer that provides an electrical signal representative of audio, although one skilled in the art will recognize that other types of transducers may be utilized as appropriate to a particular application. Such transducers typically operate by sensing changes in pressure (e.g., vibrations in strings and/or soundboard).

Piezoelectric transducers are often used in under saddle pickups on stringed instruments like guitars. These types of pickups typically capture an even response across the strings and have high resistance to feedback. They can be more invasive to install and they usually require fitment into a saddle slot and shaving material from the bottom of the saddle to offset the size of the transducer.

Embodiments of the invention utilize piezoelectric transducers in a soundboard contact pickup system in certain configurations that have the advantages of under saddle pickups in contrast to existing soundboard contact pickups, which are prone to feedback. The disclosed pickups have attributes for stage presence, better sound, better string to string balance, and are easier to install than existing pickups. Experimentation by the inventors has found that properties such as certain shapes and/or dimensions of a pickup housing, a central placement of a transducer within the pickup housing, as well as the arrangement of multiple pickups across a set of strings can result in a high quality audio signal from the pickup system that is true to the sound of the instrument, has good string to string balance, minimizes extraneous distortions, and has a high feedback threshold.

Embodiments of the invention recognize that placement of a piezo within the pickup housing and spacing to the walls of the housing can drastically impact the sound quality and accuracy of the sound output produced by the pickup. In many prior art pickups, the piezo contacts an interior side of the pickup housing directly or through a metallic (e.g., brass) base, substrate, or shielding. Even if not contacting the pickup housing, the piezo is typically offset at least some distance from the center of the of the pickup body. This is often due to the conventional belief that a transducer should be as close as possible to the vibrating surface that it is sensing, having the view that adding distance changes the way it reacts to the surface negatively or unpredictably. Thus, many existing transducer pickups for stringed instruments mount to the bridge plate, which is on the underside of the instrument top and opposite of the bridge that serves as an end contact point for the strings. These existing bridge plate transducer pickups usually have minimal layers of material between the transducer sensor and the surface it is mounted to. These types of pickups are also very prone to feedback and having a low feedback threshold.

In many embodiments of the invention, a piezo is suspended in the center of a pickup housing, equidistant from the walls or sides of the pickup housing. The piezo can be suspended in, for example, hardened epoxy as will be discussed further below. Also differing from prior pickup designs, in certain embodiments the piezo is not mounted to any substrate or printed circuit board, allowing it to respond more freely to vibrational forces through the pickup.

In some embodiments, the piezo is the same distance from at least the top (away from the soundboard) and bottom (toward the soundboard) sides of the pickup housing. In further embodiments, the piezo is 0.13″ from the top side and 0.13″ from the bottom side of the pickup housing. In additional embodiments, the piezo is also 0.13″ from the front, rear, left, and/or right sides of the pickup housing. In some more embodiments, the piezo is at least 0.13″ from any of the sides of the pickup housing.

In further embodiments of the invention, a pickup system can include multiple pickups where the dimensions of the pickup housing and positions of the pickups in relation to the locations and spacing of the strings provides an even response in the contributions of the multiple strings to the combined audio signal of the pickups. In some embodiments, the pickup system includes at least one pickup where the piezo is equidistant to at least four walls of the pickup housing.

### Construction

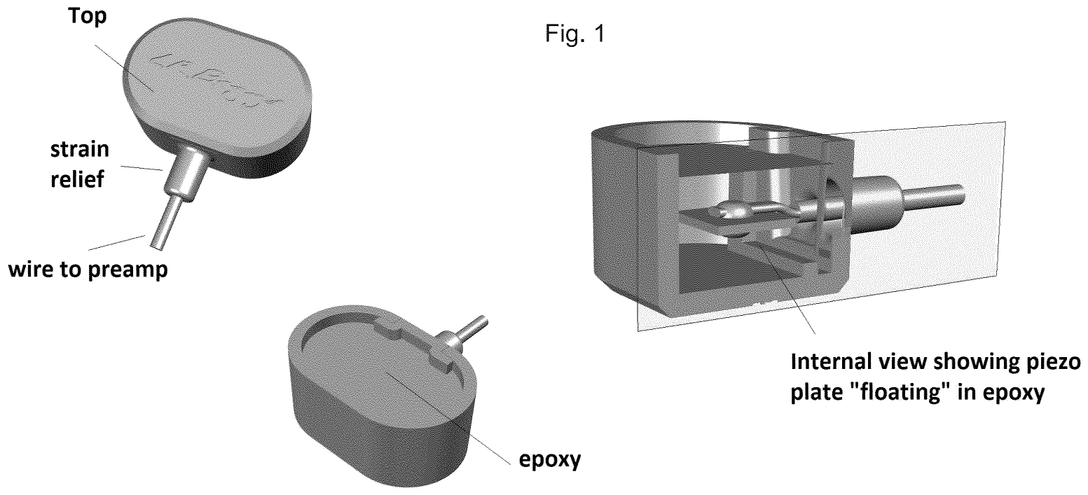

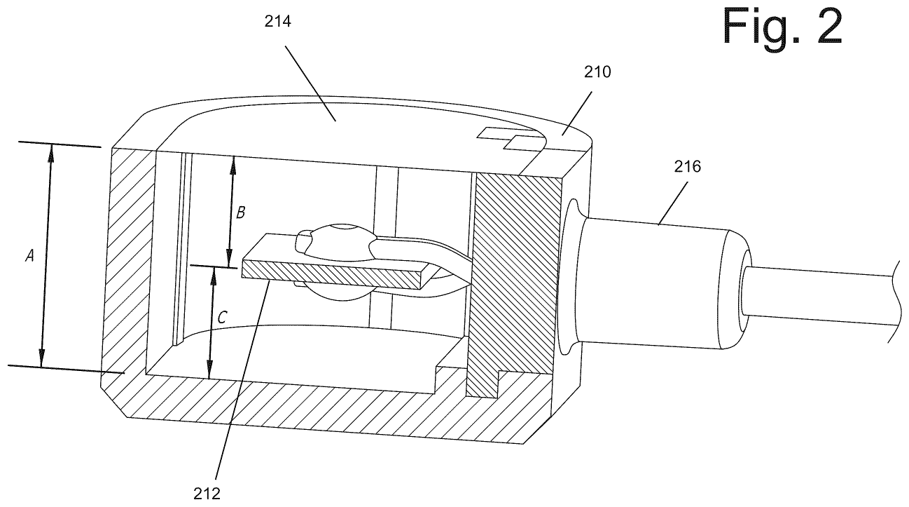

A soundboard transducer pickup in accordance with embodiments of the invention includes a pickup housing, a piezo sensor, epoxy potting, adhesive, a signal wire (e.g., coaxial cable) from the piezo sensor that can lead to a preamplifier. Soundboard transducer pickups in accordance with embodiments of the invention are illustrated in FIGS. 1 and 2.

The pickup housing 210 in many embodiments is a plastic or other rigid material that is vibrationally conductive. The material may also be electrically conductive. As will be discussed further below, enclosing the piezo in electrically conductive material can act as a faraday shield to reduce hum in the signal. In several embodiments the material is not electrically conductive. In some embodiments of the invention, the pickup housing has a flat top and bottom and a pill-shaped perimeter (e.g., flat front and rear and rounded sides). The pickup housing may be formed as a shell with top, front, rear, left, and right sides as walls and the remaining bottom side as open to be filled with another material such as epoxy as discussed further below. After filling, the material forms a bottom surface of the pickup. Other structures may be utilized according to embodiments of the invention as appropriate to a particular application.

In the illustrated embodiment, the piezo sensor 212 is suspended in the center of the pickup housing. As mentioned above, the distance of the piezo sensor to the walls of the pickup housing can positively impact the sound produced by the piezo sensor. The key is controlling leverage, the distance of the piezo to the instrument surface, which is determined by the spacing of the piezo within the pickup housing and the dimensions of the portions of the pickup housing between the piezo and the instrument surface. Being suspended away from the walls of the pickup housing allows the piezo to free to flex equally in both directions—in bending and sheer.

In several embodiments, the piezo sensor is not mounted to any substrate, such as brass or PCB (printed circuit board) material. Being attached to such a rigid surface would constrain how the piezo bends and affect responsiveness to vibrations. The piezo sensor can be shaped as a square or rectangle, 1 mm or 0.5 mm plate.

In many embodiments of the invention, the space within the pickup housing surrounding the piezo sensor is occupied by epoxy 214 or another material, which can be placed by a potting process such as the processes discussed further below. In many embodiments, the epoxy potting or other material fills all the empty space directly around the piezo and between the piezo and the inside surfaces of the pickup housing. Other materials may be used for filling, such as UV cured materials, polyester resin, or overmolded plastic.

In some embodiments of the invention, a strain relief portion 216 (e.g., for protecting the signal wire) of the pickup housing can be formed separately from the pickup housing. The strain relief portion can be affixed to the signal wire and piezo sensor before placement into the pickup housing. The strain relief portion can then be fitted to its complementary area on the pickup housing, e.g., by a slot or set of slots.

The placement of the piezo sensor within the pickup housing in several embodiments of the invention can be important to the tuning of drive to the piezo. In some embodiments, its position at a specific distance from the front, back, and side walls should be the same. An interior view showing the location of a piezo sensor in accordance with an embodiment of the invention is illustrated in FIG. 2. In the illustrated embodiment, the overall distance A from top wall to bottom surface is 0.26″. The piezo sensor is spaced 0.13″ B from the bottom surface and 0.13″ C from the top wall. In some embodiments, the piezo sensor is centrally located between the side walls, which can be spaced from 0.13″ to 0.22″ away to each side wall.

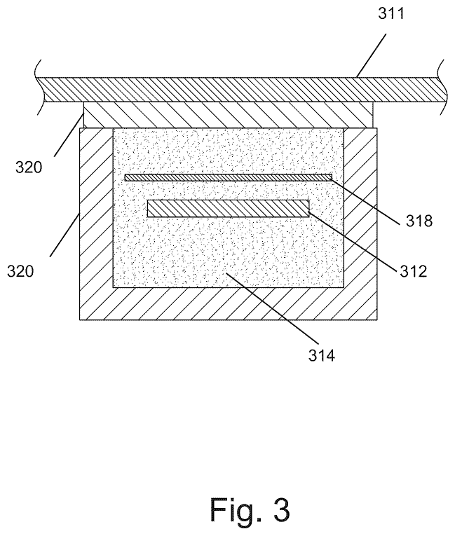

Some additional embodiments of the invention include shielding between the piezo sensor and the side of the housing that will face the instrument soundboard 311, as shown in FIG. 3. The shielding 318 can be a thin, porous mesh of a metal such as, but not limited to, copper or bronze that is embedded within the epoxy 314. The shielding could also be a vacuum metalized layer or conductive paint. In embodiments where other walls 320 of the housing are electrically conductive (e.g., electrically conductive plastic), the shield together with the walls can substantially enclose the piezo 312 to provide a faraday shield effect to reduce hum picked up by the piezo.

Adhesive 320 may be placed on one side of the pickup housing that faces or intended to face the instrument soundboard. Many embodiments of the invention utilize an acrylic foam adhesive, which is high performing and consistent. Some acrylic foam adhesives that may be used can be slightly elastic and relatively thin at less than 0.025″.

In some embodiments of the invention, pickup housings have a specific ratio of length to width. Development of aspects of the invention has found that this ratio can impact controlling lower frequencies. In certain embodiments, the ratio of width to length of a pickup housing is 1 to 1.5. For example, some pickup housings are 0.525″ wide and 0.800″ long. In further embodiments, the height is 0.300″. When the piezo is suspended in the center of the housing, changing the height would change the distance of the piezo to the soundboard. A greater distance would result in a less direct signal and more from movement. A difference of about 25% more or less in height could still be used in various embodiments of the invention.

While specific structures of transducer pickups are discussed above with respect to FIGS. 1-3, one skilled in the art will recognize that any of a variety of structures may be utilized in accordance with embodiments of the invention as may be appropriate to a particular application.

### Pickup Mounting

Acoustic guitars typically have a spacing of 0.425″ between strings, which may vary slightly depending on some specific styles, sizes, or manufacturers. In some embodiments of the invention, a system with pickups having dimensions as discussed above can accommodate for these slight variations in string spacing, e.g., six string guitars with 2 1/16 to 2⅜″ total spacing. These dimensions are suitably small to fit onto most guitar bridge plates, which have limited space.

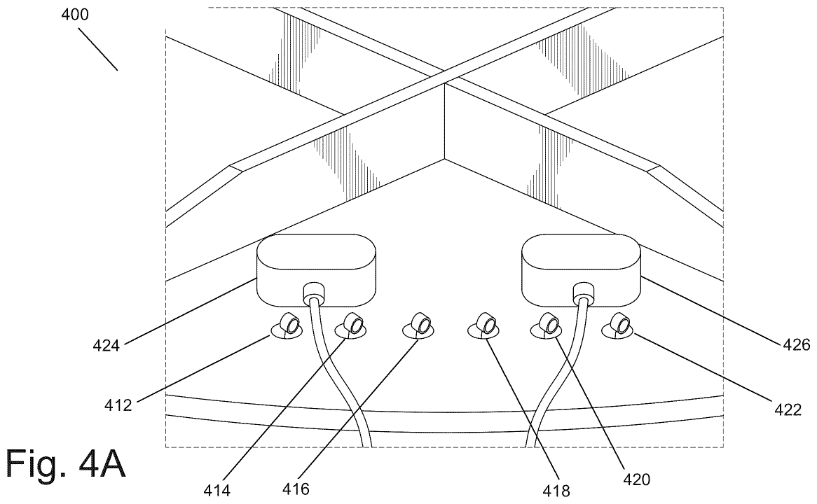

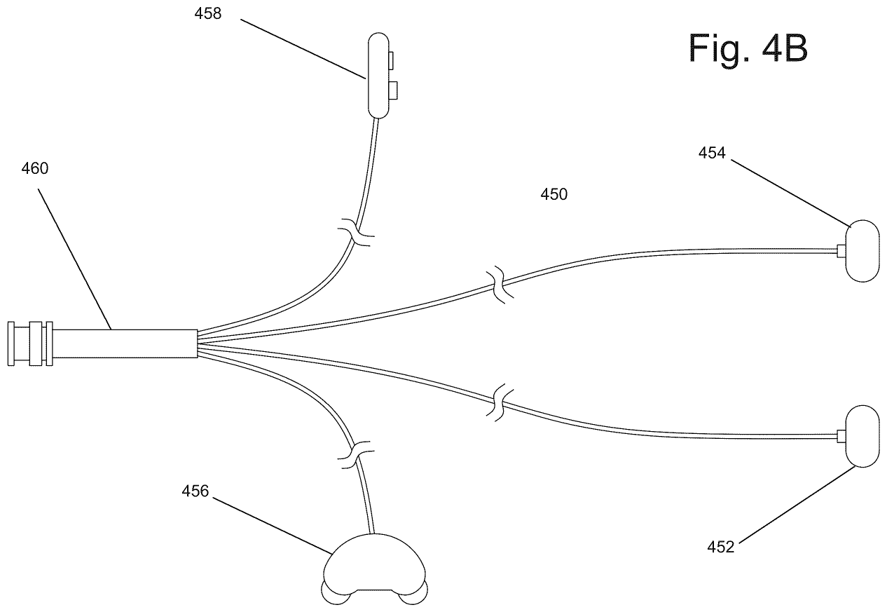

An example of mounting a two pickup system inside an acoustic guitar is illustrated in FIG. 4A. The illustration shows the underside of an acoustic guitar top (soundboard). Cross braces are illustrated at the upper portion of the drawing and a bridge plate with the ends of six strings 412, 414, 416, 418, 420, and 422 at the bottom portion of the drawing.

In several embodiments of the invention, the pickups 424 and 426 of a two sensor pickup system 400 are placed such that the center of the first pickup is approximately in the middle between the first 412 and second strings 414, and the center of the second pickup is approximately in the middle between the fifth 420 and sixth 422 strings. The rounded ends of the pickups extend slightly past the proximate strings. With this arrangement, each pickup 424 426 receives a strong signal from the proximate strings (the first 412 and second 414 strings and the fifth 420 and sixth 424 strings, respectively) and roughly half as strong a signal from the farther strings (the third 416 and fourth 418 strings). When the signals are blended from the two pickups, the signals of the third and fourth strings combine to result in a similar level as the other strings.

While a specific mounting arrangement is discussed above, one skilled in the art will recognize that any of a number of mounting arrangements may be utilized according to embodiments of the invention as appropriate to a particular application.

### Preamplifier

Several embodiments of the invention utilize a preamplifier (preamp) for the pickup. In many embodiments, the preamp can include circuitry for a band of compression in the 5 Khz range, a steep high pass filter, and/or a notch at 150 Hz. An active acoustic pickup system including a preamp in accordance with an embodiment of the invention is shown in FIG. 4B. The pickup system includes two soundboard transducer pickups 452 and 454, a control element with two thumb knobs 456, a power terminal 458 (that may be connected to a battery or other power source) and an endpin jack 460 (that can house a preamp).

While a specific preamplifier system is discussed above, one skilled in the art will recognize that any of a number of preamplifier systems may be utilized according to embodiments of the invention as appropriate to a particular application.

### Processes for Assembling a Pickup

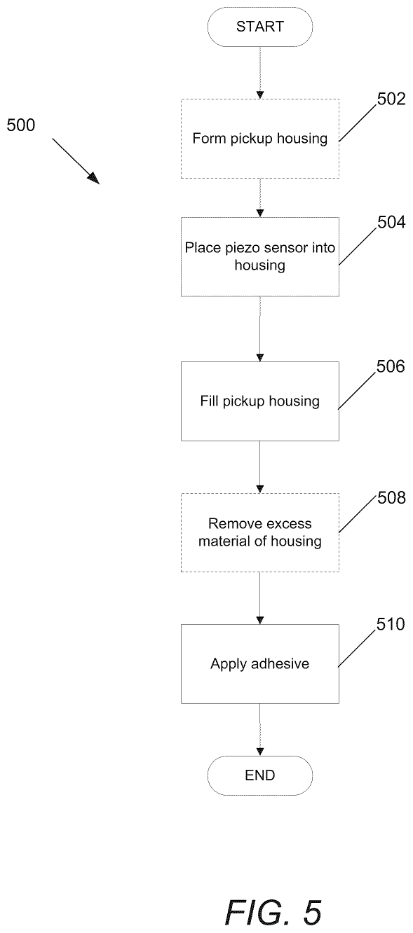

A process for assembling an acoustic pickup in accordance with embodiments of the invention is illustrated in FIG. 5. The process 500 includes forming (502) a pickup housing. In many embodiments of the invention, the pickup housing is plastic. The pickup housing can be formed by injection molding, overmolding, 3D printing, or any of a variety of other techniques. In several embodiments of the invention, the pickup housing is a multi-sided shape with at least one side open and the interior hollow.

A piezo sensor is suspended (504) into the interior of the pickup housing by wire or other bracing and connected with a signal lead to the exterior of the pickup housing. In many embodiments of the invention, the piezo sensor is not connected directly to a substrate or printed circuit board, as it can be supported by being surrounded by a hard material as will be discussed below.

In some embodiments, a mount for the piezo sensor is formed together with a strain relief around the signal lead that attaches to the pickup housing. The strain relief portion can be fitted to the pickup housing as the piezo sensor is introduced to the interior of the pickup housing.

The hollow shell of the pickup housing is filled (506) or “potted.” Potting can include filling the shell with liquid epoxy that then hardens (e.g., by curing). Other techniques can be used to fill the shell in accordance with embodiments of the invention. In many embodiments, the potting or other material fills all the empty space directly around the piezo and between the piezo and the inside surfaces of the pickup housing. Other materials may be used for filling, such as UV cured materials, polyester resin, or overmolding plastic.

In several embodiments of the invention, some edges of the pickup housing may still extend beyond the surface of the epoxy after the epoxy filling. The excess material can optionally be removed (508), such as by machining, to create a uniform surface. In some embodiments, the side of the pickup having excess edges and where the hardened epoxy is exposed is machined to a flat surface. In other embodiments, the excess material may not be removed. Instead, that side may be positioned away from the soundboard as mentioned below or another panel of material may be placed over it to provide a uniform appearance.

Adhesive is applied (510) to the pickup and it can be mounted to a musical instrument soundboard. As mentioned above, an acrylic foam adhesive can be used. In many embodiments, the adhesive is placed on the flat machined surface of the pickup. In still further embodiments of the invention, any excess material need not be removed as mentioned above. The side having excess material can be positioned away from the soundboard by placing the adhesive on one of the originally closed sides of the pickup housing (e.g., a side opposite of the side left open for filling and having excess material after filling).

While a specific assembly process arrangement is discussed above, one skilled in the art will recognize that any of a number of processes may be utilized according to embodiments of the invention as appropriate to a particular application.

### Overmolding Assembly

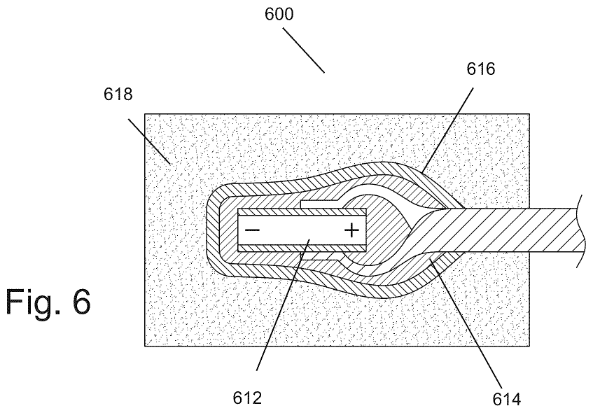

In additional embodiments of the invention, overmolding can be utilized to assemble a soundboard transducer pickup. FIG. 6 illustrates a cross section view of an overmolded pickup 600.

In the illustrated embodiment, the piezo sensor 612 is soldered onto the positive and negative/ground signal lead wires. The assembly is coated with an insulating material 614 (e.g., clear epoxy), which can be applied in a variety of ways, such as by dipping into the insulating material while it is in liquid form and then hardening/curing the insulating material.

A conductive shield or shielding material 616 can cover the sensor assembly coated in insulating material, by mechanical attachment or by coating with a shielding paint. Then the entire assembly can be overmolded with a hard material 618 (e.g., plastic) to form the body of the pickup.

While the above description contains many specific embodiments of the invention, these should not be construed as limitations on the scope of the invention, but rather as an example of one embodiment thereof. Accordingly, the scope of the invention should not be limited to the specific embodiments illustrated.

What is claimed is:

1. A transducer pickup system for acoustic stringed instruments, the system comprising:
at least two pickups, each pickup comprising a pickup housing and a bottom surface, the pickup housing having sides comprising at least a top wall;
each pickup comprising an electromechanical transducer surrounded by a solid non-conductive material and located the same distance from the top wall and the bottom surface; and
each pickup comprising adhesive on one of the sides of the pickup housing configured to mount the pickup to the underside of the soundboard of an acoustic stringed instrument.

2. The transducer pickup system of claim 1, where each pickup housing is made of a rigid material.

3. The transducer pickup system of claim 1, wherein each pickup housing further comprises a front wall, a rear wall, a left wall and a right wall;
each electromechanical transducer is located the same distance from the front wall and the rear wall; and
each electromechanical transducer is located the same distance from the left wall and the right wall.

4. The transducer pickup system of claim 3, where the left wall and right wall are convex semi-circular in shape.

5. The transducer pickup system of claim 3, where the ratio of width, from front wall to rear wall, to length, from left wall to right wall, is 1 to 1.5.

6. The transducer pickup system of claim 5, where the width is 0.525″ and the length is 0.800″.

7. The transducer pickup system of claim 6, where the height is 0.300″.

8. The transducer pickup system of claim 1, where each pickup housing is made of an electrically conductive plastic.

9. The transducer pickup system of claim 1, where at least one electromechanical transducer is a piezoelectric transducer.

10. The transducer pickup system of claim 9, where each piezoelectric transducer is not directly affixed to a printed circuit board (PCB).

11. The transducer pickup system of claim 1, where the solid non-conductive material is epoxy potting.

12. The transducer pickup system of claim 11, where the epoxy potting forms the bottom surface.

13. The transducer pickup system of claim 1, where the solid-non-conductive material is overmolded plastic and is unitary with the pickup housing.

14. The transducer pickup system of claim 1, further comprising a strain relief portion formed separately from the pickup housing and fitting into each pickup housing to surround signal wires that lead from the electromechanical transducer.

15. The transducer pickup system of claim 1, where each pickup further comprises a metallic shielding near the electromechanical transducer and int the direction of an open side of the pickup housing.

16. The transducer pickup system of claim 1, where the adhesive is acrylic foam adhesive.

17. The transducer pickup system of claim 1, further comprising a preamplifier configured to combine and amplify signals from the at least two pickups.

18. The transducer pickup system of claim 17, where the preamplifier includes circuitry for a band of compression in the 5 Khz range, a steep high pass filter, and/or a notch at 150 Hz.

19. The transducer pickup system of claim 1, wherein a first pickup of the at least two pickups is mounted under a soundboard of a stringed instrument across two highest strings of the stringed instrument and a second pickup of the at least two pickups is mounted across two lowest strings of the stringed instrument.

20. The transducer pickup system of claim 1, where each pickup is mounted to the bridge plate of the acoustic stringed instrument, where the acoustic stringed instrument is an acoustic guitar.

21. A transducer pickup system for stringed instruments, the system comprising:
at least two pickups, each pickup comprising a pickup housing and a bottom surface, the pickup housing having sides comprising at least a top wall;
each pickup comprising a piezoelectric transducer surrounded by epoxy potting and located the same distance from the top wall and the bottom surface; and
wherein each pickup housing further comprises a front wall, a rear wall, a left wall and a right wall;
wherein each piezoelectric transducer is located the same distance from the front wall and the rear wall;
wherein each piezoelectric transducer is located the same distance from the left wall and the right wall; and
where the ratio of width, from front wall to rear wall, to length, from left wall to right wall, is 1 to 1.5.

22. A transducer pickup system for stringed instruments, the system comprising:
at least two pickups, each pickup comprising a pickup housing and a bottom surface, the pickup housing having sides comprising at least a top wall and the pickup housing is made of an electrically conductive plastic;
each pickup comprising a piezoelectric transducer surrounded by epoxy potting and located the same distance from the top wall and the bottom surface; and
each pickup comprising acrylic foam adhesive on one of the sides of the pickup housing;
wherein each pickup housing further comprises a front wall, a rear wall, a left wall and a right wall;
wherein each piezoelectric transducer is located the same distance from the front wall and the rear wall;
wherein each piezoelectric transducer is located the same distance from the left wall and the right wall;
where the ratio of width, from front wall to rear wall, to length, from left wall to right wall, is 1 to 1.5;
where the left wall and right wall are convex semi-circular in shape; and
where the epoxy potting forms the bottom surface.

23. A transducer pickup system for stringed instruments, the system comprising:
at least two pickups, each pickup comprising a pickup housing and a bottom surface, the pickup housing having sides comprising at least a top wall;
each pickup comprising a piezoelectric transducer surrounded by a solid nonconductive material;
the solid nonconductive material surrounded by metallic shielding; and
the metallic shielding surrounded by a block of epoxy potting comprising a front surface, a rear surface, a top surface, a bottom surface, a left side surface, and a right side surface;
where each piezoelectric transducer is located the same distance from the top surface and the bottom surface of the block of epoxy potting;
wherein each piezoelectric transducer is located the same distance from the front surface and the rear surface;
wherein each piezoelectric transducer is located the same distance from the left side surface and the right side surface; and
where the ratio of width, from front surface to rear surface, to length, from left side surface to right side surface, is 1 to 1.5.
